(19) United States
(12) Patent Application Publication
(10) Pub. No.: US 2026/0337929 A1
(43) Pub. Date: Oct. 29, 2026

(54) WORK MACHINE

(71) Applicant: KOMATSU LTD., Minato-ku, Tokyo (JP)

(72) Inventors: Junichi MURAKAMI, Minato-ku, Tokyo (JP); Masanori UEDA, Minato-ku, Tokyo (JP); Yasuyuki SUZUKI, Minato-ku, Tokyo (JP); Kouhei MIYAZAKI, Minato-ku, Tokyo (JP)

(73) Assignee: KOMATSU LTD., Minato-ku, Tokyo (JP)

(21) Appl. No.: 18/995,389

(22) PCT Filed: Aug. 9, 2023
(86) PCT No.: PCT/JP2023/029060

§ 371 Date: Jan. 16, 2025

(30) Foreign Application Priority Data
Aug. 23, 2022 (JP) 2022-132572

(51) Int. Cl. E02F 9/26; E02F 9/08

(52) U.S. Cl. CPC E02F 9/261; E02F 9/0866; E02F 9/0891

(57) ABSTRACT

A machinery compartment exterior covers a machinery compartment. A detector detects external information of a hydraulic excavator. The machinery compartment exterior includes a cover member extending in a frontward/rearward direction in an upper portion of the machinery compartment exterior. The detector includes a portion located on a side of the machinery compartment with respect to the cover member.

### TECHNICAL FIELD

The present disclosure relates to a work machine.

### BACKGROUND ART

In recent years, a camera is installed in a work machine such as a hydraulic excavator such that surroundings can be visually checked during work or the like. A configuration in which a camera is installed in a work machine is disclosed, for example, in Japanese Patent Laying-Open Nos. 2008-150832 (PTL 1), 2017-89139 (PTL 2), and the like.

In Japanese Patent Laying-Open No. 2008-150832, a rear monitoring camera and a casing supporting the rear monitoring camera are disposed on a counterweight. In Japanese Patent Laying-Open No. 2017-89139, a camera is disposed on an upper revolving unit.

### CITATION LIST

### Patent Literature

PTL 1: Japanese Patent Laying-Open No. 2008-150832
PTL 2: Japanese Patent Laying-Open No. 2017-89139

### SUMMARY OF INVENTION

### Technical Problem

In each of the above-mentioned two literatures, a detector such as a camera for detecting external information of the work machine is disposed to protrude from the counterweight or the upper revolving unit. Thus, the detector may be damaged when it interferes with an obstacle during work of the work machine.

An object of the present disclosure is to provide a work machine capable of suppressing damage to a detector.

### Solution to Problem

A work machine according to the present disclosure is a work machine including a machinery compartment, and includes a machinery compartment exterior and a detector. The machinery compartment exterior covers the machinery compartment. The detector detects external information of the work machine. The machinery compartment exterior includes a cover member extending in a frontward/rearward direction in an upper portion of the machinery compartment exterior. The detector includes a portion located on a side of the machinery compartment with respect to the cover member.

### Advantageous Effects of Invention

According to the present disclosure, a work machine capable of suppressing damage to the detector can be implemented.

### BRIEF DESCRIPTION OF DRAWINGS

FIG. 1 is a side view showing a configuration of a hydraulic excavator according to one embodiment of the present disclosure.

FIG. 2 is a top view of a part of the hydraulic excavator in FIG. 1.

FIG. 3 is a schematic cross-sectional view taken along a line III-III in FIG. 2.

FIG. 4 is an enlarged perspective view of a portion equipped with an imaging device in the hydraulic excavator in FIG. 1 shown from outside the hydraulic excavator. FIG. 5 is an enlarged perspective view of a portion equipped with the imaging device in the hydraulic excavator in FIG. 1 shown from inside the hydraulic excavator.

FIG. 6 is a cross-sectional view of a portion equipped with the imaging device in the hydraulic excavator in FIG. 1.

FIG. 7 is an enlarged perspective view of a portion equipped with an antenna in the hydraulic excavator in FIG. 1 shown from outside the hydraulic excavator.

FIG. 8 is an enlarged perspective view of a portion equipped with the antenna in the hydraulic excavator in FIG. 1 shown from inside the hydraulic excavator.

FIG. 9 is a cross-sectional view of a portion equipped with the antenna in the hydraulic excavator in FIG. 1.

### DESCRIPTION OF EMBODIMENTS

Hereinafter, embodiments of the present disclosure will be described with reference to the accompanying drawings.

In the specification and accompanying drawings, the same or corresponding components are denoted by the same reference characters, and the same description thereof will not be repeated. In the accompanying drawings, the configuration may be omitted or simplified for convenience of description. The embodiments and modifications thereof may at least partially be arbitrarily combined with each other.

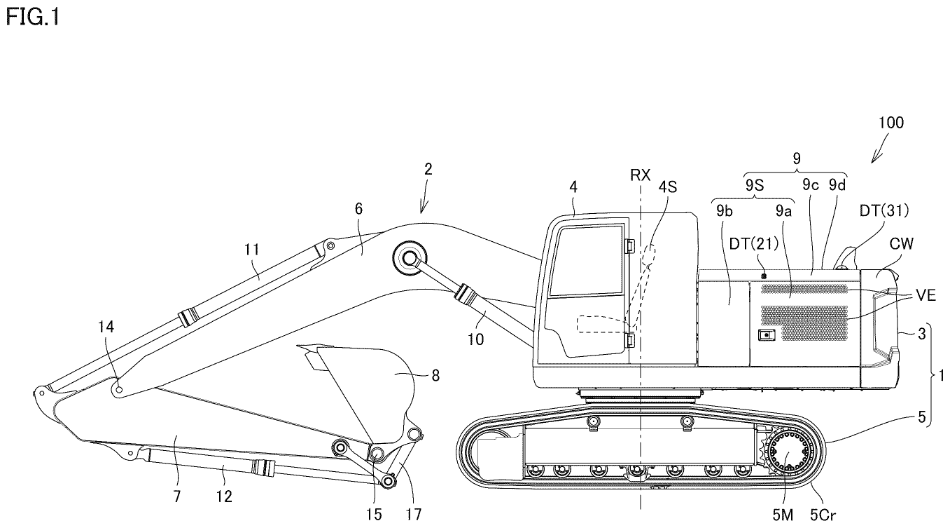

The present disclosure is applicable not only to a hydraulic excavator but also to other work machines such as a wheel loader, a bulldozer, and a motor grader. In the following description, the terms “upper”, “lower”, “front”, “rear”, “left”, and “right” indicate the directions with reference to an operator seated on an operator's seat 4S in a cab 4 shown in FIG. 1.

### Configuration of Work Machine

First, a configuration of a hydraulic excavator will be described as an example of a work machine in the present embodiment with reference to FIG. 1.

FIG. 1 is a side view schematically showing a configuration of a hydraulic excavator according to one embodiment of the present disclosure. As shown in FIG. 1, a hydraulic excavator 100 includes a main body 1 and a work implement 2 activated by hydraulic pressure. Main body 1 includes a revolving unit 3 and a travel unit 5. Travel unit 5 includes a crawler belt 5Cr and a travel motor 5M. Hydraulic excavator 100 can travel by the rotation of crawler belt 5Cr. Travel motor 5M is provided as a drive source of travel unit 5. Travel motor 5M is a hydraulic motor activated by hydraulic pressure. Travel unit 5 may include a wheel (a tire).

Revolving unit 3 is disposed on travel unit 5 and supported by travel unit 5. Revolving unit 3 is revolvable with respect to travel unit 5 about a revolution axis RX. Revolving unit 3 includes a cab 4 (an operator's cab). Operator's seat 4S on which an operator is seated is provided inside cab 4. An operator (an occupant) who is seated inside cab 4 can control work implement 2, control revolving unit 3 to revolve with respect to travel unit 5, and control travel unit 5 to run hydraulic excavator 100.

Revolving unit 3 includes a machinery compartment exterior 9 and a counterweight CW provided at a rear portion of revolving unit 3. Machinery compartment exterior 9 covers a machinery compartment. In the machinery compartment, an engine unit (an engine, an exhaust treatment structure, and the like), or a battery unit (a battery, a motor, an inverter, and the like) are disposed. When the battery unit is disposed in the machinery compartment, counterweight CW may not be provided. In this case, the battery unit serves as a counterweight.

Work implement 2 is supported by revolving unit 3. Work implement 2 includes a boom 6, an arm 7, and a bucket 8. Work implement 2 further includes a boom cylinder 10, an arm cylinder 11, and a bucket cylinder 12.

Boom 6 is pivotably connected to main body 1 (travel unit 5 and revolving unit 3). Specifically, boom 6 has a proximal end pivotably connected to revolving unit 3 about a boom foot pin (not shown) as a fulcrum.

Arm 7 is pivotably connected to boom 6. Specifically, arm 7 has a proximal end pivotably connected to a distal end of boom 6 about a boom top pin 14 as a fulcrum. Bucket 8 is rotatably connected to arm 7. Specifically, bucket 8 has a proximal end pivotably connected to a distal end of arm 7 about an arm top pin 15 as a fulcrum.

Boom cylinder 10 has one end connected to revolving unit 3 and the other end connected to boom 6. Boom 6 is drivable with respect to main body 1 by boom cylinder 10. Such driving allows boom 6 to be pivotable in an upward/downward direction with respect to revolving unit 3 about the boom foot pin as a fulcrum.

Arm cylinder 11 has one end connected to boom 6 and the other end connected to arm 7. Arm 7 is drivable with respect to boom 6 by arm cylinder 11. Such driving allows arm 7 to be pivotable in the upward/downward direction or the frontward/rearward direction with respect to boom 6 about boom top pin 14 as a fulcrum.

Bucket cylinder 12 has one end connected to arm 7 and the other end connected to a bucket link 17. Bucket 8 is drivable with respect to arm 7 by bucket cylinder 12. Such driving allows bucket 8 to be pivotable in the upward/downward direction with respect to arm 7 about arm top pin 15 as a fulcrum.

Machinery compartment exterior 9 includes a side plate portion 9S, a cover member 9c, and a hood portion 9d. Side plate portion 9S is disposed on a side surface of revolving unit 3. Side plate portion 9S constitutes a side surface of machinery compartment exterior 9 to cover a lateral side of the machinery compartment. Side plate portion 9S includes a door 9a and a side plate 9b.

Door 9a is disposed on a side surface of revolving unit 3. Door 9a is disposed, for example, adjacent to counterweight CW. Door 9a allows the machinery compartment to be opened and closed. Door 9a is provided with a plurality of intake/exhaust holes VE. Each of the plurality of intake/exhaust holes VE connects the machinery compartment to the outside of hydraulic excavator 100.

Side plate 9b is a side surface of revolving unit 3 and disposed between door 9a and cab 4. Side plate 9b is arranged side by side with door 9a in the frontward/rearward direction. Side plate 9b is disposed in front of door 9a. Hood portion 9d constitutes a top plate of machinery compartment exterior 9. Hood portion 9d covers an upper area of the machinery compartment. The upper surface of hood portion 9d may be entirely flat or may partially have a flat portion.

Cover member 9c is disposed at a corner portion between side plate portion 9S and hood portion 9d of machinery compartment exterior 9. Cover member 9c is disposed at each end of machinery compartment exterior 9 in a rightward/leftward direction. Cover member 9c is disposed to extend in the frontward/rearward direction in an upper portion of machinery compartment exterior 9. Cover member 9c is disposed on both door 9a and side plate 9b. Cover member 9c is disposed between cab 4 and counterweight CW. Cover member 9c extends in the frontward/rearward direction from a rear end of cab 4 to a front end of counterweight CW.

Cover member 9c may also serve as a handrail seat. In other words, a handrail (not shown) may be attached to cover member 9c. The handrail serves as a portion to be gripped by a worker who stands on an upper surface of machinery compartment exterior 9. A seat (not shown) may be attached to cover member 9c, and the handrail may be attached to the sheet.

Hydraulic excavator 100 includes a detector DT. Detector DT detects external information of hydraulic excavator 100. Detector DT is, for example, an imaging device 21 or an antenna 31. Detector DT may be a radar, light detection and ranging (LiDAR), an ultrasonic sensor, or the like. Detector DT may be formed of one of imaging device 21, antenna 31, the radar, the LiDAR, and the ultrasonic sensor, or may include any combination thereof. The external information of hydraulic excavator 100 may be an image of a target located outside hydraulic excavator 100, a distance to the target, the properties of the target, or the like, or may be a signal transmitted from the outside of hydraulic excavator 100.

Imaging device 21 captures an image of the outside of hydraulic excavator 100. Imaging device 21 is, for example, a camera. Imaging device 21 is disposed, for example, on a side surface of revolving unit 3. Imaging device 21 may be disposed on a rear surface, a front surface, or an upper surface of revolving unit 3.

Antenna 31 wirelessly receives information from the outside of hydraulic excavator 100. Antenna 31 is, for example, a global navigation satellite system (GNSS) antenna. Antenna 31 is disposed, for example, on the upper surface of revolving unit 3. Antenna 31 may be disposed on the rear surface, the front surface, or the side surface of revolving unit 3.

Hydraulic excavator 100 may include electrical components such as an illumination device. The illumination device illuminates the lateral side, the front side, the rear side, and the like of hydraulic excavator 100. The illumination device includes at least one of a light-emitting diode (LED), a fluorescent lamp, and an incandescent lamp.

Each of detector DT and the electrical components is attached to main body 1 of hydraulic excavator 100. Each of detector DT and the electrical components is attached, for example, to revolving unit 3. Each of detector DT and the electrical components has a portion covered by machinery compartment exterior 9.

### Arrangement of Detector DT

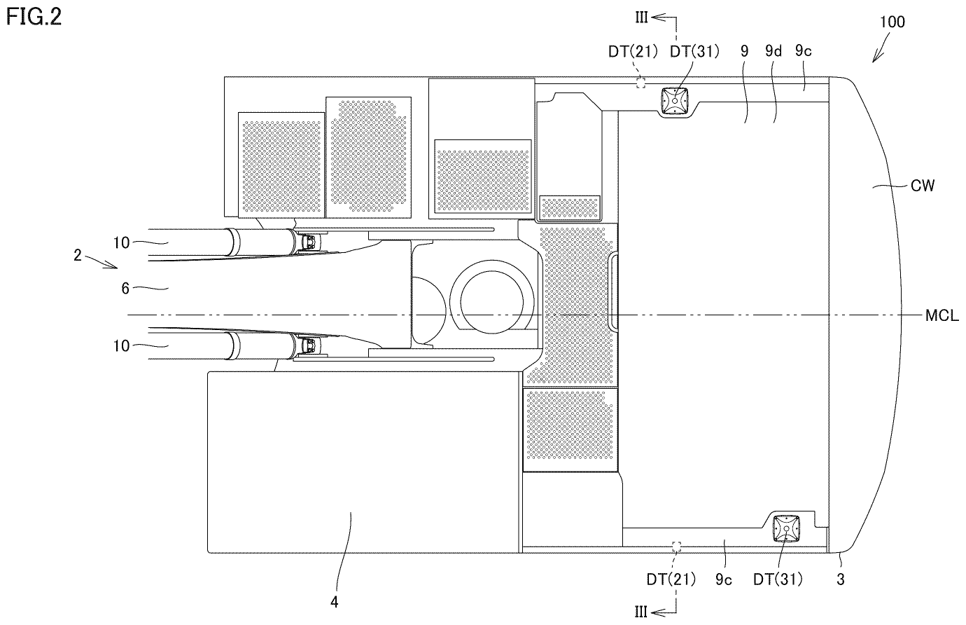

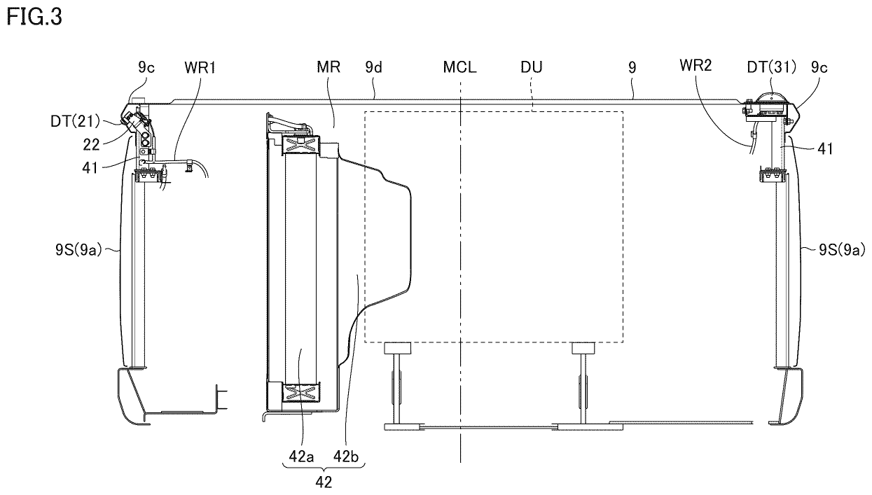

The following describes the arrangement of detector DT in hydraulic excavator 100 according to the present embodiment with reference to FIGS. 2 and 3.

FIG. 2 is a top view of a part of the hydraulic excavator in FIG. 1. FIG. 3 is a schematic cross-sectional view taken along a line III-III in FIG. 2.

As shown in FIG. 2, a plurality of detectors DT may be disposed in revolving unit 3. The plurality of detectors DT may include a plurality of imaging devices 21 and a plurality of antennas 31. The plurality of imaging devices 21 may include imaging device 21 disposed on one side surface of revolving unit 3 and imaging device 21 disposed on the other side surface of revolving unit 3. Two imaging devices 21 are disposed on the opposite sides with respect to a center MCL (a two-dot chain line) of hydraulic excavator 100 in the rightward/leftward direction. In other words, one imaging device 21 is disposed on the side of one side surface with respect to center MCL while the other imaging device 21 is disposed on the side of the other side surface opposite to one imaging device 21 with respect to center MCL.

Imaging device 21 disposed on the side of one side surface and imaging device 21 disposed on the side of the other side surface in the top view are positioned to be not axisymmetric with respect to center MCL but may be positioned to be axisymmetric with respect to center MCL.

The plurality of antennas 31 may include antenna 31 disposed on the side of one side surface of revolving unit 3 and antenna 31 disposed on the side of the other side surface of revolving unit 3. Two antennas 31 are disposed on the opposite sides with respect to center MCL of hydraulic excavator 100 in the rightward/leftward direction. In other words, one antenna 31 is disposed on the side of one side surface with respect to center MCL while the other antenna 31 is disposed on the side of the other side surface opposite to one antenna 31 with respect to center MCL.

Antenna 31 disposed on the side of one side surface and antenna 31 disposed on the side of the other side surface in the top view are positioned to be not axisymmetric with respect to center MCL, but may be positioned to be axisymmetric with respect to center MCL.

The top view refers to a point of view seen downward from above in the direction perpendicular to a flat portion of hood portion 9d in machinery compartment exterior 9.

As shown in FIG. 3, machinery compartment exterior 9 covers the left and right sides and the upper side of a machinery compartment MR. Machinery compartment exterior 9 may cover the front side and the rear side of machinery compartment MR.

The space covered by machinery compartment exterior 9 is machinery compartment MR. In machinery compartment MR, a drive unit DU, a cooling unit 42, and the like are disposed.

Drive unit DU may be an engine unit (an engine, an exhaust treatment structure, and the like) or a battery unit (a battery, and the like). Cooling unit 42 includes: a heat exchanger 42a such as an oil cooler or a radiator; and a fan 42b.

As shown in FIGS. 2 and 3, each of the plurality of detectors DT is disposed on the machinery compartment MR side with respect to cover member 9c. The machinery compartment MR side with respect to cover member 9c means that detector DT is disposed inside machinery compartment MR or detector DT is disposed outside machinery compartment MR but closer to machinery compartment MR than cover member 9c is.

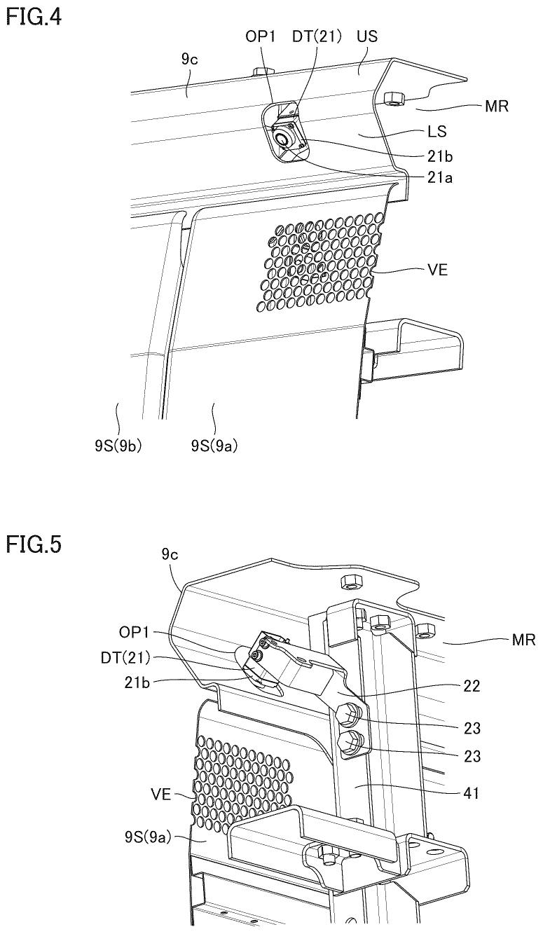

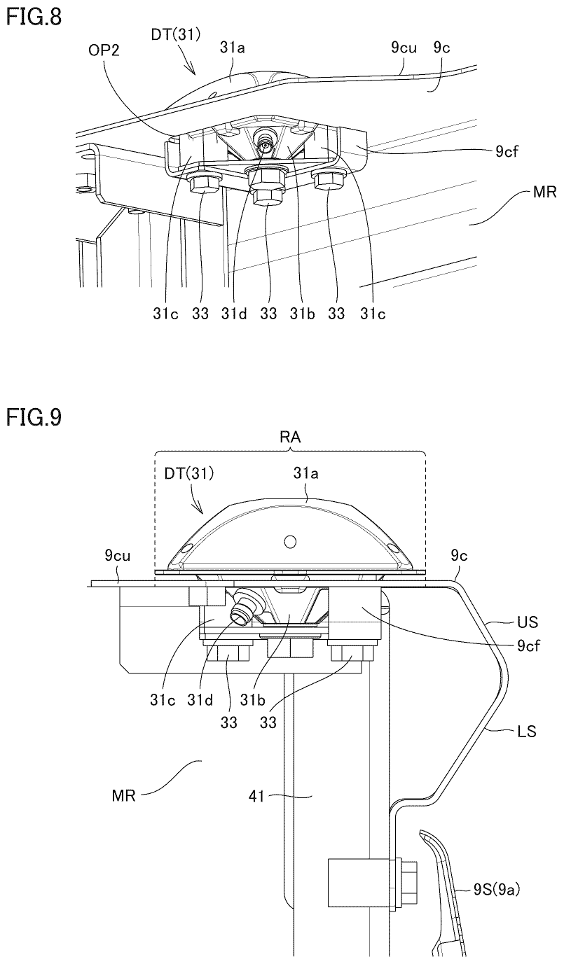

Each of the plurality of detectors DT is exposed to the outside of cover member 9c via through holes OP1 and OP2 (FIGS. 4 and 8) provided in cover member 9c. The outside of cover member 9c refers to a space on the side opposite to machinery compartment MR with respect to cover member 9c. The outside of cover member 9c corresponds to a space outside machinery compartment MR. The outside of cover member 9c also corresponds to a space outside hydraulic excavator 100.

Each of the plurality of detectors DT is exposed to the outside of cover member 9c and thereby can detect external information of hydraulic excavator 100. In the case where detector DT is imaging device 21, imaging device 21 is exposed to the outside of cover member 9c and thereby can capture an image of a target outside hydraulic excavator 100. In the case where detector DT is antenna 31, antenna 31 is exposed to the outside of cover member 9c and thereby can receive a signal transmitted from the outside of hydraulic excavator 100. In the case where detector DT is a radar, LiDAR, an ultrasonic sensor, or the like, detector DT is exposed to the outside of cover member 9c and thereby can detect an image of a target outside hydraulic excavator 100, a distance to the target, properties of the target, and the like.

As shown in FIG. 3, in a cross-sectional view, detector DT includes a portion disposed on the machinery compartment MR side with respect to cover member 9c.

The portion of detector DT that is disposed on the machinery compartment MR side with respect to cover member 9c refers to a case portion of detector DT.

In the case where detector DT is, for example, imaging device 21, at least a part of the case portion accommodating an optical system, an imaging element, and the like is disposed on the machinery compartment MR side with respect to cover member 9c. In the case where detector DT is, for example, antenna 31, at least a part of the case portion accommodating an antenna reception unit, a circuit board, and the like is disposed on the machinery compartment MR side with respect to cover member 9c.

In the case where detector DT is, for example, a radar, LiDAR, or an ultrasonic sensor, at least a part of the case portion accommodating an irradiation unit (a unit for irradiation with radio waves, light, ultrasonic waves, or the like), a measurement unit (a unit for measurement of scattering of radio waves, light, ultrasonic waves, or the like), and the like is disposed on the machinery compartment MR side with respect to cover member 9c.

If detector DT does not include a portion disposed in machinery compartment MR but includes a portion disposed in a space partitioned from machinery compartment MR, detector DT includes a portion located closer to machinery compartment MR than cover member 9c is. In the case where detector DT is imaging device 21 and includes a portion disposed in a space partitioned from machinery compartment MR, at least a part of the case portion of imaging device 21 is located closer to machinery compartment MR than cover member 9c is. Further, in the case where detector DT is antenna 31 and includes a portion disposed in a space partitioned from machinery compartment MR, at least a part of the case portion of antenna 31 is located closer to machinery compartment MR than cover member 9c is. Further, in the case where detector DT is, for example, a radar, LiDAR, or an ultrasonic sensor and includes a portion disposed in a space partitioned from machinery compartment MR, at least a part of the case portion of imaging device 21 is located closer to machinery compartment MR than cover member 9c is.

Each of a portion of connection between the case portion of imaging device 21 and a wire WR1 and a portion of connection between the case portion of antenna 31 and a wire WR2 is disposed on the machinery compartment MR side with respect to cover member 9c. Each of the portion of connection between the case portion of imaging device 21 and wire WR1 and the portion of connection between the case portion of antenna 31 and wire WR2 is located inside a space surrounded by machinery compartment exterior 9 (inside machinery compartment MR or inside a space partitioned from machinery compartment MR).

Wires WR1 and WR2 are also disposed on the machinery compartment MR side with respect to cover member 9c. Wires WR1 and WR2 are located inside a space surrounded by machinery compartment exterior 9 (inside machinery compartment MR or inside a space partitioned from machinery compartment MR).

Further, in the case where an electrical component such as an illumination device is disposed, the electrical component may be disposed on the machinery compartment MR side with respect to cover member 9c. This electrical component may be located inside a space surrounded by machinery compartment exterior 9 (inside machinery compartment MR or inside a space partitioned from machinery compartment MR).

### Specific Configuration and Arrangement of Imaging Device 21

The following describes a specific configuration and arrangement of imaging device 21 according to the present embodiment with reference to FIGS. 4 to 6.

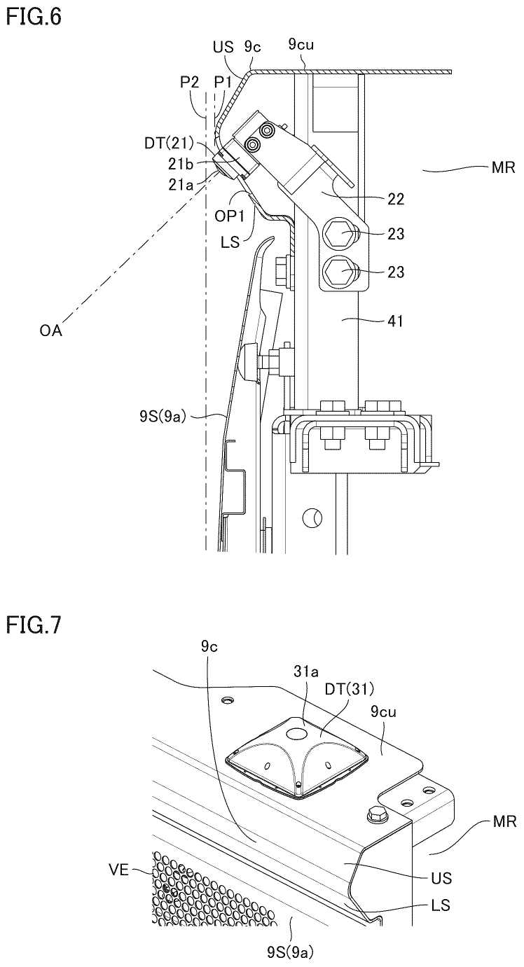

FIG. 4 is an enlarged perspective view of a portion equipped with an imaging device in the hydraulic excavator in FIG. 1 shown from outside the hydraulic excavator. FIG. 5 is an enlarged perspective view of a portion equipped with the imaging device in the hydraulic excavator in FIG. 1 shown from inside the hydraulic excavator. FIG. 6 is a cross-sectional view of a portion equipped with the imaging device in the hydraulic excavator in FIG. 1.

As shown in FIG. 4, cover member 9c is provided with through hole OP1. A part of imaging device 21 is inserted into through hole OP1. Specifically, a part of a case portion 21b of imaging device 21 is inserted into through hole OP1.

Imaging device 21 includes an imaging element, an optical system, and case portion 21b. Each of the imaging element and the optical system is accommodated inside case portion 21b. The imaging element photoelectrically converts the contrast of brightness of light into an amount of electric charge. The imaging element is, for example, an image sensor such as a complementary metal oxide semiconductor (CMOS) sensor or a charge coupled device (CCD) sensor. The optical system includes a lens, a mirror, and the like, and forms an image of a subject on the imaging element. The optical system includes a lens 21a exposed to the outside of case portion 21b. Imaging device 21 may further include a cover. The cover of imaging device 21 is, for example, a lens protective cover for protecting lens 21a and made of a transparent member.

As shown in FIG. 5, case portion 21b of imaging device 21 is attached to a frame 41 with a support 22 interposed therebetween. Support 22 is fixed to case portion 21b. Support 22 is attached to frame 41 by a fixing member 23. Fixing member 23 is, for example, a bolt.

A part of case portion 21b and support 22 are disposed on the machinery compartment MR side with respect to cover member 9c. Cover member 9c may be attached to frame 41 by bolts or the like.

As shown in FIG. 6, cover member 9c includes a first inclined portion US and a second inclined portion LS. First inclined portion US is inclined to protrude to the outside (for example, to the lateral side) of hydraulic excavator 100 downward from above. Second inclined portion LS is located below first inclined portion US. Second inclined portion LS is inclined to protrude to the outside (for example, to the lateral side) of hydraulic excavator 100 upward from below. A lower end of first inclined portion US is connected to an upper end of second inclined portion LS. A portion of connection between first inclined portion US and second inclined portion LS forms a convex-shaped corner portion protruding from machinery compartment MR.

Through hole OP1 of cover member 9c is provided in second inclined portion LS. Through hole OP1 extends from the upper end of second inclined portion LS to a position slightly higher than the lower end of second inclined portion LS. Case portion 21b of imaging device 21 extends through the through hole OP1 to be located on both the machinery compartment MR side and the side opposite thereto with respect to cover member 9c. Lens 21a of imaging device 21 is located on the side opposite to machinery compartment MR with respect to cover member 9c. Lens 21a protrudes more to the outside (the lateral side) of hydraulic excavator 100 than second inclined portion LS does. An optical axis OA of imaging device 21 extends, for example, obliquely downward from lens 21a. Lens 21a is exposed to the outside of cover member 9c via through hole OP1. In the case where imaging device 21 includes the above-mentioned cover, at least one constituent member of lens 21a and the cover should only be exposed to the outside of cover member 9c via through hole OP1. For example, in the case where the imaging element, the optical system, and the cover are supported in this order by case portion 21b, only the cover should only be exposed to the outside of cover member 9c via through hole OP1.

A position P1 of the outermost end of cover member 9c in the rightward/leftward direction is located on an inner side of main body 1 (revolving unit 3) in the rightward/leftward direction with respect to a position P2 of the outermost end of door 9a in the rightward/leftward direction. In other words, position P1 of the outermost end of cover member 9c is located closer to machinery compartment MR than position P2 of the outermost end of door 9a is.

A one-dot chain line representing position P2 is in contact with the outermost end of door 9a in the rightward/leftward direction at a position below the portion shown in FIG. 6.

### Configuration and Arrangement of Antenna 31

The following describes a specific configuration and arrangement of antenna 31 according to the present embodiment with reference to FIGS. 7 to 9.

FIG. 7 is an enlarged perspective view of a portion equipped with an antenna in the hydraulic excavator in FIG. 1 shown from outside the hydraulic excavator. FIG. 8 is an enlarged perspective view of a portion equipped with the antenna in the hydraulic excavator in FIG. 1 shown from inside the hydraulic excavator. FIG. 9 is a cross-sectional view of a portion equipped with the antenna in the hydraulic excavator in FIG. 1.

As shown in FIGS. 7 and 8, antenna 31 includes an upper case 31a and a lower case 31b. Lower case 31b is attached below upper case 31a. Upper case 31a and lower case 31b constitute a case portion of antenna 31. In an internal space surrounded by upper case 31a and lower case 31b, an antenna reception unit, a circuit board, and the like are disposed.

As shown in FIG. 7, upper case 31a of antenna 31 is disposed outside machinery compartment MR. Specifically, upper case 31a is located above a top plate portion 9cu of cover member 9c.

As shown in FIG. 8, cover member 9c is provided with through hole OP2. Through hole OP2 is provided in top plate portion 9cu of cover member 9c. Lower case 31b of antenna 31 is inserted into through hole OP2 and protrudes toward machinery compartment MR from cover member 9c. Lower case 31b may protrude toward machinery compartment MR via through hole OP2 or may protrude to a space partitioned from machinery compartment MR.

Lower case 31b is provided with a fixed portion 31c and a terminal portion 31d. Fixed portion 31c has a female thread portion. Fixed portion 31c is fixed by a fixing member 33 such as a bolt to a support portion 9cf fixed to the bottom surface of top plate portion 9cu.

Terminal portion 31d is electrically connected to the antenna reception unit of antenna 31. Terminal portion 31d serves as a portion to which wire WR2 (FIG. 3) and the like are electrically connected. When wire WR2 is connected to terminal portion 31d, a signal received by the antenna reception unit through wire WR2 can be extracted from antenna 31.

Each of lower case 31b, fixed portion 31c, and terminal portion 31d is located on the machinery compartment MR side with respect to cover member 9c. Each of lower case 31b, fixed portion 31c, and terminal portion 31d may be disposed in machinery compartment MR or may be disposed in a space partitioned from machinery compartment MR.

As shown in FIG. 9, top plate portion 9cu of cover member 9c includes an attachment region RA to which antenna 31 is attached. Attachment region RA overlaps with upper case 31a of antenna 31 in a top view. In attachment region RA, the upper surface of top plate portion 9cu is flat.

### Effects

The following describes the effects of the present embodiment.

In the present embodiment, as shown in FIG. 3, detector DT includes a portion located on the machinery compartment MR side with respect to cover member 9c. Thereby, the size of protrusion of detector DT from machinery compartment exterior 9 can be reduced. This makes it possible to suppress detector DT from interfering with an obstacle and thus suffering damage.

Further, the configuration in which detector DT is disposed on the machinery compartment MR side with respect to cover member 9c can be easily applied to other models (for example, higher models) of hydraulic excavator 100 with the use of the same cover member 9c.

Further, in the present embodiment, as shown in FIG. 6, at least one constituent member of lens 21a and the cover of imaging device 21 is exposed to the outside of cover member 9c via through hole OP1 provided in second inclined portion LS.

Second inclined portion LS is inclined to protrude to the outside of hydraulic excavator 100 upward from below. Thereby, moisture from rain or the like that has streamed down on the outer surface of cover member 9c is less likely to enter the inside of cover member 9c (the machinery compartment MR side) via through hole OP1, so that imaging device 21 is less likely to be wet with water.

Further, second inclined portion LS is inclined to protrude to the outside of hydraulic excavator 100 upward from below. Thus, when optical axis OA of imaging device 21 extends obliquely downward from lens 21a or the cover, second inclined portion LS is prevented from interfering with the range imaged by imaging device 21.

Further, the portion of connection between first inclined portion US and second inclined portion LS of cover member 9c protrudes toward the outside of hydraulic excavator 100 above imaging device 21 to thereby function as an eaves. Thus, the portion of imaging device 21 that protrudes outward from cover member 9c via through hole OP1 is less likely to be wet with rain or the like.

Further, optical axis OA of imaging device 21 extends obliquely downward from lens 21a or the cover. Thus, lens 21a or the cover is less likely to be wet with rain or the like.

Further, in the present embodiment, as shown in FIG. 6, position P1 of the outermost end of cover member 9c is located on an inner side of position P2 of the outermost end of door 9a in the rightward/leftward direction, door 9a being located below cover member 9c. Thus, cover member 9c is less likely to interfere with an obstacle outside hydraulic excavator 100.

Further, in the present embodiment, as shown in FIG. 9, the top surface of top plate portion 9cu of cover member 9c is flat in attachment region RA to which antenna 31 is attached. This makes it easy to closely attach the bottom surface of antenna 31 to the upper surface of top plate portion 9cu in attachment region RA. Therefore, moisture, dust, and the like are prevented from entering the inside of machinery compartment exterior 9 from the outside thereof via through hole OP2 of cover member 9c into which antenna 31 is inserted.

Further, in the present embodiment, as shown in FIGS. 5 and 6, support 22 that supports detector DT is located on the machinery compartment MR side with respect to cover member 9c. Thereby, support 22 does not protrude to the outside of cover member 9c, so that support 22 is prevented from interfering with an obstacle outside hydraulic excavator 100.

### Additional Aspects

The above description includes features additionally described below.

### Additional Aspect 1

A work machine including a machinery compartment, the work machine comprising:
a machinery compartment exterior that covers the machinery compartment; and
a detector that detects external information of the work machine, wherein
the machinery compartment exterior includes a cover member extending in a frontward/rearward direction in an upper portion of the machinery compartment exterior, and
the detector includes a portion located on a side of the machinery compartment with respect to the cover member.

### Additional Aspect 2

The work machine according to Additional Aspect 1, wherein
the detector includes an imaging device including at least one constituent member of a lens and a cover,
the cover member includes a first inclined portion and a second inclined portion connected to the first inclined portion,
the first inclined portion is inclined to protrude to an outside of the work machine downward from above, and the second inclined portion is inclined to protrude to the outside of the work machine upward from below, and
the at least one constituent member of the imaging device is exposed to an outside of the cover member via a through hole provided in the second inclined portion.

The detector may be formed of the imaging device alone or may include other devices (an antenna, a radar, LiDAR, an ultrasonic sensor) other than the imaging device.

### Additional Aspect 3

The work machine according to Additional Aspect 1 or 2, wherein
the machinery compartment exterior includes a door located below the cover member, and
a position of an outermost end of the cover member is located on an inner side of a position of an outermost end of the door in a rightward/leftward direction.

### Additional Aspect 4

The work machine according to any one of Additional Aspects 1 to 3, wherein
the detector includes an antenna,
an upper surface of the cover member includes an attachment region to which the antenna is attached, and
the upper surface of the cover member is flat in the attachment region.

The detector may be formed of the antenna alone or may include other devices (an imaging device, a radar, LiDAR, an ultrasonic sensor) other than the antenna.

### Additional Aspect 5

The work machine according to any one of Additional Aspects 1 to 4, further comprising a support that supports the detector, wherein
the support is located on the side of the machinery compartment with respect to the cover member.

It should be understood that the embodiments disclosed herein are illustrative and non-restrictive in every respect. The scope of the present invention is defined by the terms of the claims, rather than the above description, and is intended to include any modifications within the meaning and scope equivalent to the terms of the claims.

### REFERENCE SIGNS LIST

1 main body, 2 work implement, 3 revolving unit, 4 cab, 4S operator's seat, 5 travel unit, 5Cr crawler belt, 5M travel motor, 6 boom, 7 arm, 8 bucket, 9 machinery compartment exterior, 9S side plate portion, 9a door, 9b side plate, 9c cover member, 9cf support portion, 9cu top plate portion, 9d hood portion, 10 boom cylinder, 11 arm cylinder, 12 bucket cylinder, 14 boom top pin, 15 arm top pin, 17 bucket link, 21 imaging device, 21a lens, 21b case portion, 22 support, 23, 33 fixing member, 31 antenna, 31a upper case, 31b lower case, 31c fixed portion, 31d terminal portion, 41 frame, 42 cooling unit, 42a heat exchanger, 42b fan, 100 hydraulic excavator, CW counterweight, DT detector, DU drive unit, LS second inclined portion, MR machinery compartment, OA optical axis, OP1, OP2 through hole, P1, P2 position, RA attachment region, US first inclined portion, VE intake/exhaust hole, WR1, WR2 wire.

1. A work machine including a machinery compartment, the work machine comprising:
a machinery compartment exterior that covers the machinery compartment; and
a detector that detects external information of the work machine, wherein
the machinery compartment exterior includes a cover member extending in a frontward/rearward direction in an upper portion of the machinery compartment exterior, and
the detector includes a portion located on a side of the machinery compartment with respect to the cover member.

2. The work machine according to claim 1, wherein
the detector includes an imaging device including at least one constituent member of a lens and a cover,
the cover member includes a first inclined portion and a second inclined portion connected to the first inclined portion,
the first inclined portion is inclined to protrude to an outside of the work machine downward from above, and the second inclined portion is inclined to protrude to the outside of the work machine upward from below, and
the at least one constituent member of the imaging device is exposed to an outside of the cover member via a through hole provided in the second inclined portion.

3. The work machine according to claim 1, wherein
the machinery compartment exterior includes a door located below the cover member, and
a position of an outermost end of the cover member is located on an inner side of a position of an outermost end of the door in a rightward/leftward direction.

4. The work machine according to claim 1, wherein
the detector includes an antenna,
an upper surface of the cover member includes an attachment region to which the antenna is attached, and
the upper surface of the cover member is flat in the attachment region.

5. The work machine according to claim 1, further comprising a support that supports the detector, wherein
the support is located on the side of the machinery compartment with respect to the cover member.
